(19) United States
(12) Patent Application Publication
(10) Pub. No.: US 2017/0356689 A1
(43) Pub. Date: Dec. 14, 2017

(54) LANCE ASSEMBLY

(71) Applicant: Refractory Service Corp., East Chicago, IN (US)

(72) Inventor: Jeff Bianchi, Cedar Lake, IN (US)

(21) Appl. No.: 15/609,989

(22) Filed: May 31, 2017

Related U.S. Application Data
(60) Provisional application No. 62/343,630, filed on May 31, 2016.
(60) Provisional application No. 62/416,100, filed on Nov. 1, 2016.

(51) Int. Cl. F27D 3/16

(52) U.S. Cl. CPC F27D 3/16; F27D 2003/169

(57) ABSTRACT

The present disclosure provides a lance assembly which includes a core coupled to a manifold having a plurality of reagent outlet tubes from which a reagent and a carrier gas are expelled. The plurality of reagent outlet tubes inhibit clogging of the lance assembly and require less reagent for desulfurization.

### CROSS-REFERENCE TO RELATED APPLICATIONS

This application claims priority to U.S. Provisional Patent Application Ser. No. 62/343,630, filed May 31, 2016, and U.S. Provisional Patent Application Ser. No. 62/416,100, filed Nov. 1, 2016, the disclosures of which are hereby expressly incorporated by reference herein in its entirety.

### FIELD OF THE DISCLOSURE

The present disclosure relates to a lance assembly. More particularly, the present disclosure relates to a desulfurization lance.

### BACKGROUND OF THE DISCLOSURE

When processing steel, sulfur is an unwanted element. The presence of sulfur affects both the internal quality and the surface quality of steel and can contribute to steel brittleness. The presence of sulfur in steel also forms undesirable sulfides, which promotes granular weakness and cracks in steel during solidification. Sulfur has an adverse effect on the mechanical properties of steel and lowers the melting point, intergranular strength, and cohesion of steel. Therefore, removal of sulfur in steel is desired.

One desulfurization process requires the use of a desulfurization station where a reagent and carrier gas are injected into a mixture of hot molten steel to remove sulfur that is present within the mixture. The reagent and carrier gas may be injected into solution via an injector instrument and then presented to a lance for injection into the molten mixture. In some applications, the lance is stationary with respect to the solution, while in other applications, the lance rotates to stir or agitate the mixture, which improves the efficiency of the system and reduces overall process time as compared to the stationary lance. However, while a stationary lance may be less effective and efficient, a rotating lance incurs additional operating costs, machinery/processing units, and maintenance costs. Therefore, an improvement in the foregoing is desired where a lance is efficient, effective, and low in operation and maintenance costs.

### SUMMARY

The present disclosure provides a lance assembly which includes a core coupled to a manifold having a plurality of reagent outlet tubes from which a reagent and a carrier gas are expelled. The plurality of reagent outlet tubes inhibit clogging of the lance assembly and require less reagent for desulfurization.

In one form thereof, the present disclosure provides a lance assembly. The lance assembly includes: a refractory element having a length; a core coaxial with the refractory element and extending substantially through the length of the refractory element, the core including: a reagent pipe extending substantially through the core; a manifold coupled to the core, the manifold coupled to a plurality of reagent outlet tubes that extend from the manifold, wherein each reagent outlet tube has a curvature different from other reagent outlet tubes.

In another form thereof, the present disclosure provides a lance assembly including: a refractory element having a length; a core coaxial with the refractory element and extending substantially through the length of the refractory element, the core including: a reagent pipe extending substantially through the core; a manifold coupled to the core, the manifold coupled to a plurality of reagent outlet tubes that extend from the manifold, the plurality of reagent outlet tubes configured to substantially inhibit plugging of the lance assembly; a cage adjacent to the core, wherein the core is coaxial with the reagent tube and the reagent tube extends substantially through the cage, the cage including a plurality of apertures through which the reagent tube and the reagent outlet tubes each pass through one of the plurality of apertures.

### BRIEF DESCRIPTION OF THE DRAWINGS

The above-mentioned and other features and advantages of this disclosure, and the manner of attaining them, will become more apparent and the invention itself will be better understood by reference to the following description of embodiments of the invention taken in conjunction with the accompanying drawings, wherein:

FIG. 1 is a perspective view of a fully assembled lance assembly;

FIG. 2 is a cross-section, side elevation view taken along line II-II of an embodiment of the lance assembly of FIG. 1;

FIG. 3 is a perspective view of an upper portion of the lance assembly embodiment of FIG. 2;

FIG. 4 is a perspective view of an upper portion of the lance assembly embodiment of FIG. 2;

FIG. 5 is a side view of the upper portion of the lance assembly embodiment of FIG. 2;

FIG. 6A is a portion of an alternate lance assembly embodiment;

FIG. 6B is a front view of a bottom portion of the portion of lance assembly embodiment of FIG. 6A;

FIG. 7A is a side, plan view of the lance assembly embodiment of FIG. 6A in a landscape orientation;

FIG. 7B is an enlarged side, plan view of a lower portion of the alternate lance assembly embodiment of FIG. 6A in a landscape orientation;

FIG. 7C is a bottom, perspective view of a lower portion of the lance assembly embodiment of FIG. 6A;

FIG. 7D is a side, plan view of a portion of the alternate embodiment of the lance assembly of FIG. 6A in a landscape orientation;

FIG. 7E is a cross-sectional side, plan view of the embodiment in FIG. 7D taken along line E-E in a landscape orientation;

FIG. 8 is a top view of the lance assembly embodiment of FIG. 6A;

FIG. 9 is a top view of the lance assembly embodiment of FIG. 6A with a gas inlet omitted;

FIG. 10 is an alternate, bottom view of the lance assembly embodiment of FIG. 6A;

FIG. 11 is a perspective view of an upper portion of an alternate lance assembly embodiment;

FIG. 12 is a side view of the upper portion of the alternate lance assembly embodiment;

FIG. 13 is a perspective view of a lower portion of the alternate lance assembly embodiment of FIG. 2;

FIG. 14 is a top view of the alternate lance embodiment of FIG. 12 with a gas inlet omitted;

FIG. 15 is a top view of the alternate lance embodiment of FIG. 12;

FIG. 16 is a bottom view of the alternate lance assembly embodiment of FIG. 12;

FIG. 17 is a top view of an upper portion of an alternate lance assembly embodiment according to the present disclosure;

FIG. 18 is a top view of an upper portion of the lance assembly embodiment of FIG. 17 according to the present disclosure;

FIG. 19 is a perspective view of a lower portion of the lance assembly embodiment of FIG. 17 according to the present disclosure;

FIG. 20 is a perspective view of the lower portion of the lance assembly embodiment of FIG. 19 according to the present disclosure;

FIG. 21 is a bottom view of the lower portion of the lance assembly embodiment of FIG. 19 according to the present disclosure;

FIG. 22 is a bottom view of the alternate lance assembly embodiment of FIG. 17;

FIG. 23 is a perspective view of an alternate lance assembly;

FIG. 24 is a perspective view of a manifold shown in the alternate lance assembly of FIG. 23 according to the present disclosure;

FIG. 25 is a bottom view of the manifold of FIG. 24 shown in the alternate lance assembly of FIG. 23 according to the present disclosure; and

FIG. 26 is a perspective view of an alternate configuration of the alternate lance assembly of FIG. 23 according to the present disclosure.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

The present disclosure relates to desulfurization lances, such as lance assembly 10 described further below, which allow for a more effective and efficient distribution of reagents within a hot metal solution.

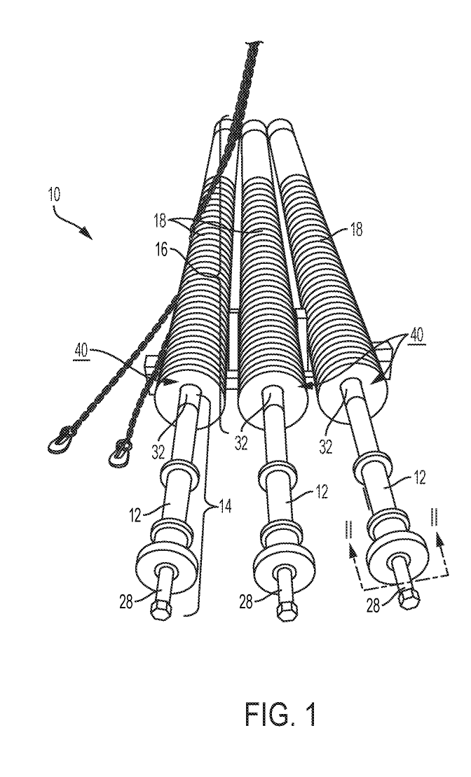

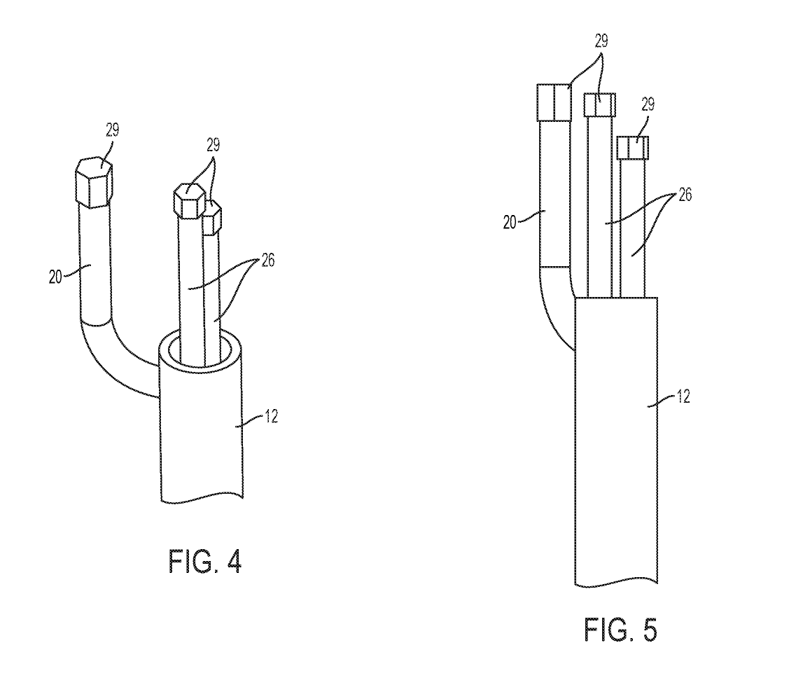

Referring to FIG. 1, multiple lance assemblies 10 are shown. As shown in FIGS. 1-4, lance assembly 10 includes an upper portion 14 and a lower portion 16 with a core 12 spanning a substantial portion of both upper portion 14 and lower portion 16. In the illustrated embodiment, core 12 is a cylinder made of steel. However, it is contemplated that in alternative embodiments, core 12 may be a rectangular prism, triangular prism, or any other suitable shape. In an alternate embodiment, core 12 is made of stainless steel, or other suitable metal.

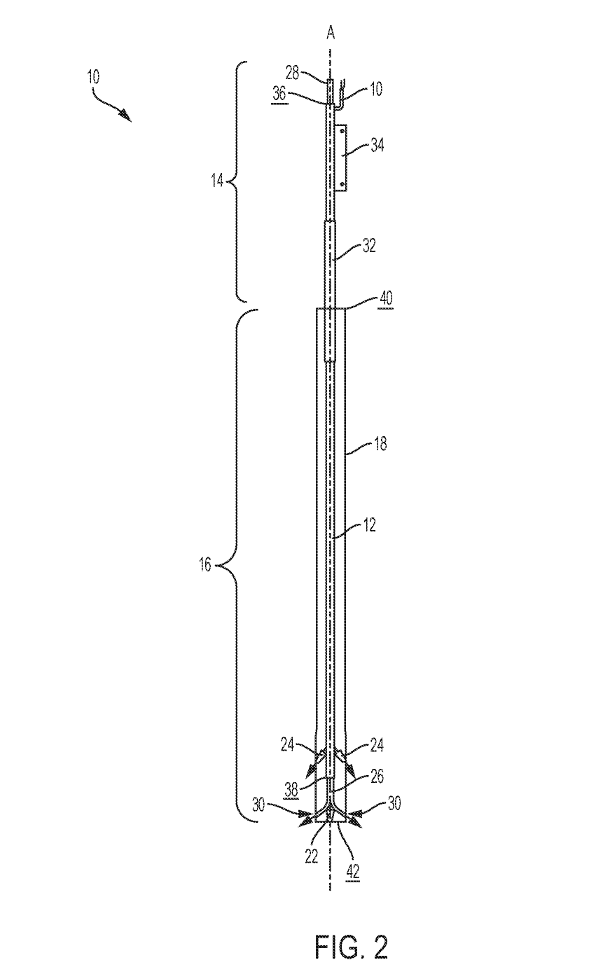

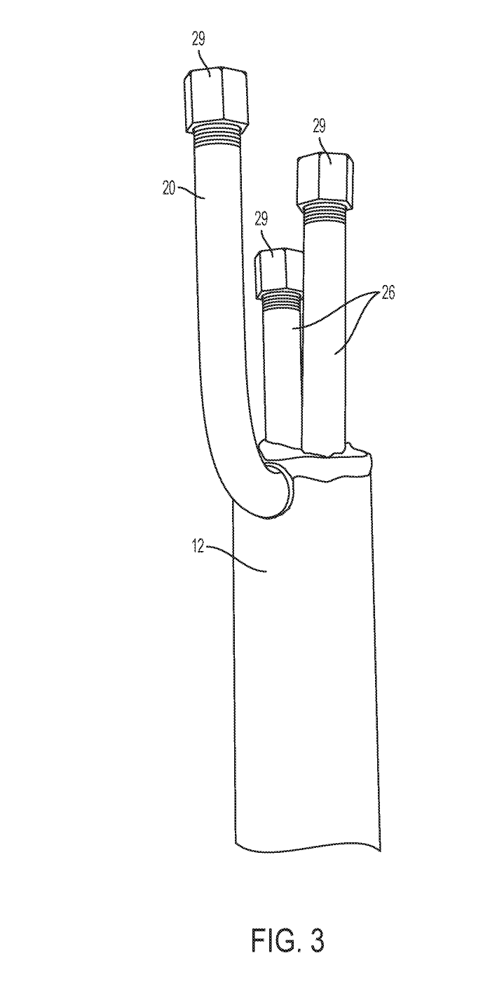

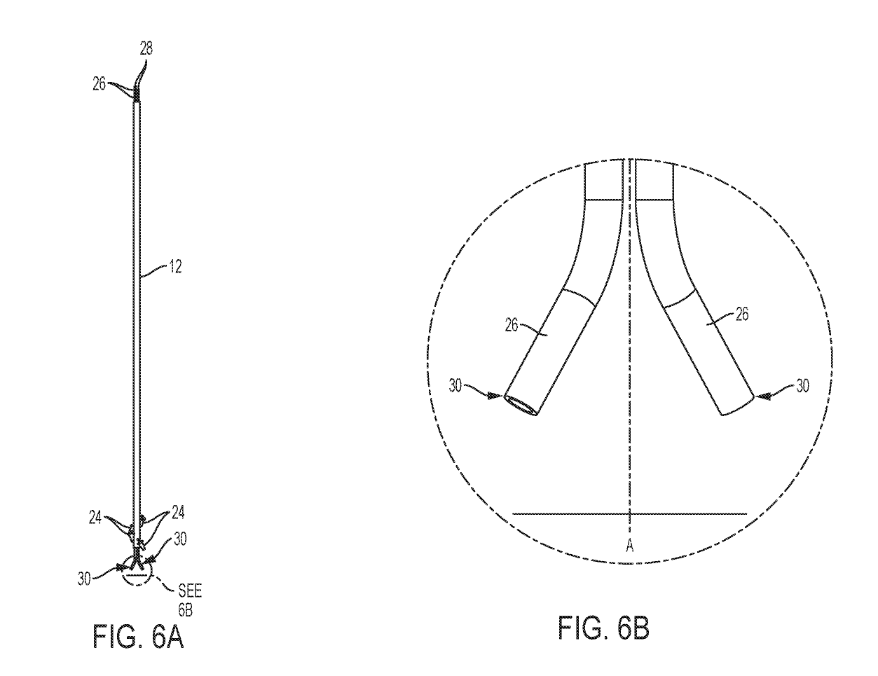

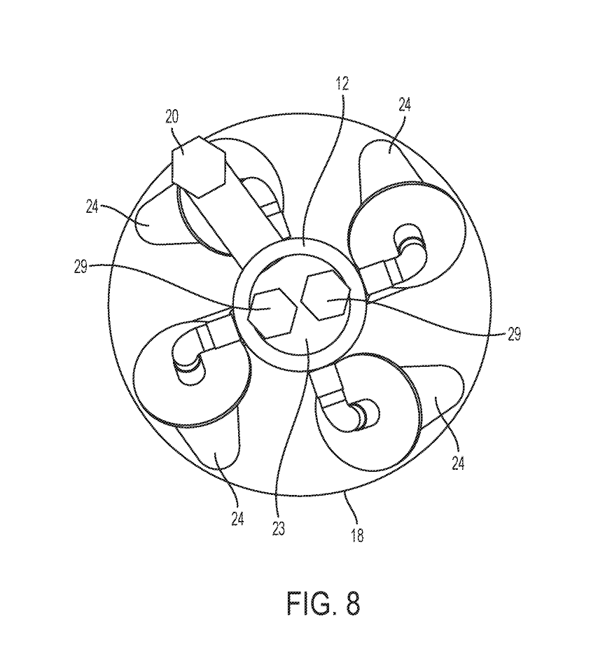

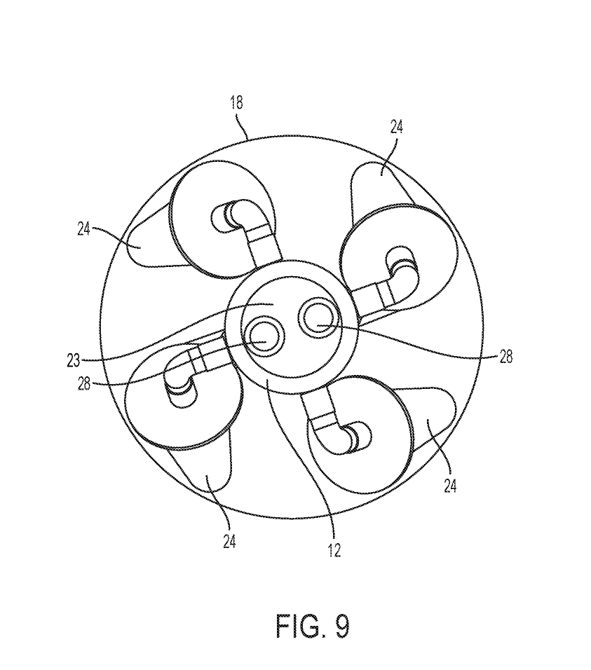

As best shown in FIGS. 2-10, core 12 includes reagent tubes 26 that span at least the entire length of core 12. Reagent tubes 26 also include reagent inlets 28 and reagent outlets 30 both of which extend outside of core 12 from top surface 36 of core 12 and bottom surface 38 of core 12, respectively. Reagent tubes 26 also include caps 29 (FIGS. 3-5) that can be removably coupled to reagent inlet 28 or gas inlet 20, thereby closing reagent tube 26 when necessary (e.g., when lance assembly 10 is not in use or undergoing maintenance). In one embodiment, cap 29 is removably coupled to reagent inlet 28 or gas inlet 20 by a plurality of grooves positioned on reagent tube 26 near reagent inlet 28 or on gas inlet 20. Cap 29 has a plurality of ridges that engage with the plurality of grooves on reagent tube 26 and gas inlet 20, thereby removably coupling cap 29 with reagent tube 26. In other words, in one embodiment, cap 29 and tube 26 have a threaded interface permitting removable coupling of cap 29 to tube 26.

Reagent tubes 26 act as carrier tubes by providing a conduit for desulfurization reagents to flow through core 12 and into a molten solution, which could be provided in a ladle (not shown). In the illustrated embodiment, reagent tubes 26 are ¾ inch diameter tubes made of steel. However, it is contemplated that in alternate embodiments, reagent tubes 26 may have other suitable diameters or be made of other suitable materials, such as stainless steel. In one exemplary embodiment, desulfurization reagents include lime and magnesium. However, it is contemplated that in alternate embodiments, other suitable desulfurization reagents may be used, such as calcium carbide, calcium oxide, calcium fluoride, magnesium oxide, and crystalline silica, or a blend thereof such as lime/spar.

FIG. 2 shows a plate 34 coupled to core 12. In one exemplary embodiment, plate 34 couples lance assembly 10 to a stationary mounting assembly (not shown). Plate 34 and stationary mounting assembly cooperate to stabilize lance assembly 10 such that there is limited excess movement of lance assembly 10 during operation. By limiting the movement of lance assembly 10, less stress is placed on the internal components of lance assembly 10 resulting in a longer overall lifespan for lance assembly 10.

As shown in FIGS. 2-5 and 8, gas inlet 20 is also coupled to core 12 adjacent to top surface 36 to form a “Y” shaped configuration with core 12 and reagent tubes 26. In an alternate embodiment, gas inlet 20 is coupled to core 12 at a different position along core 12 that may not be adjacent to top surface 36. For example, gas inlet 20 may be positioned further down and away from top surface 36 of core 12. Additionally, in a further alternate embodiment, gas inlet 20 may be coupled to core 12 such that an alternate shaped configuration is formed with core 12 and reagent tubes 26. In the illustrated embodiment, gas inlet 20 is shown to be welded to core 12 to create a closed chamber within core 12 as discussed further below. However, it is contemplated that in alternate embodiments, gas inlet 20 may be coupled to core 12 by other suitable means such as a fastener, couplers, etc.

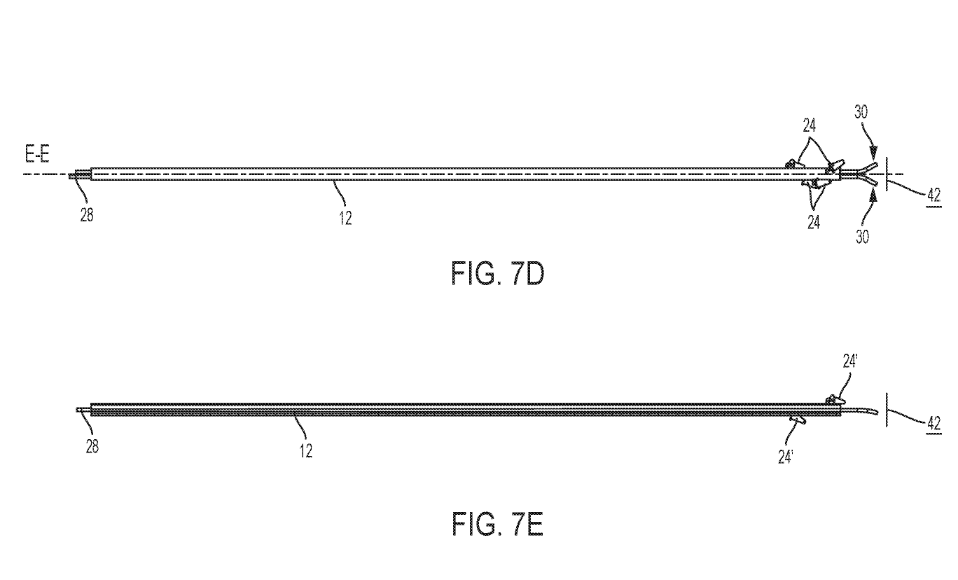

Gas inlet 20 has corresponding gas outlets 22, 24 described further below. Gas inlet 20 provides a pathway for carrier gas to enter into core 12 such that carrier gas fills the annular region 23 (FIG. 8) of core 12 outside of reagent tubes 26. In an alternate embodiment, gas inlet 20 and gas outlets 22, 24 are connected to each other by a separate tube that spans a substantial portion of the length of core 12. Carrier gas would enter though gas inlet 20 and travel through the tube and exit corresponding gas outlet 22, 24. In an exemplary embodiment, the carrier gas includes nitrogen gas or argon gas. However, it is contemplated that in alternate embodiments, other suitable carrier gasses may be used, such as helium, hydrogen, or any other inert gas.

Upper portion 14 also includes a portion of support housing 32 with the other portion of support housing 32 included in lower portion 16. Support housing 32 is coaxial with core 12; support housing 32 is also coupled to refractory element 18. In the illustrated embodiment, support housing 32 is anchored to refractory element 18 (FIG. 1) to provide a seal at the interface of support housing 32 and refractory element 18 and inhibit other materials from entering refractory element 18. However, it is contemplated that in alternate embodiments, support housing 32 is coupled to refractory element 18 by other suitable means such as couplers, fasteners, etc. comprising different sizes and types of structural steel products. Support housing 32 also functions to provide additional support to core 12 to maintain the alignment between core 12 of upper portion 14 and refractory element 18 of lower portion 16. Support housing 32 also helps to maintain the alignment between outlets 22, 24, 30 for the carrier gas and desulfurization reagents and the openings provided on refractory element 18 by coupling upper portion 14 with lower portion 16 of lance assembly 10.

Like core 12, in the illustrated embodiment, support housing 32 is in the shape of a cylinder. However, it is contemplated that in alternative embodiments, support housing 32 may be a rectangular prism, triangular prism frustoconical, or any other suitable shape. In an exemplary embodiment, support housing 32 is made of carbon steel. In an alternate embodiment, support housing 32 is made of stainless steel or other suitable metals.

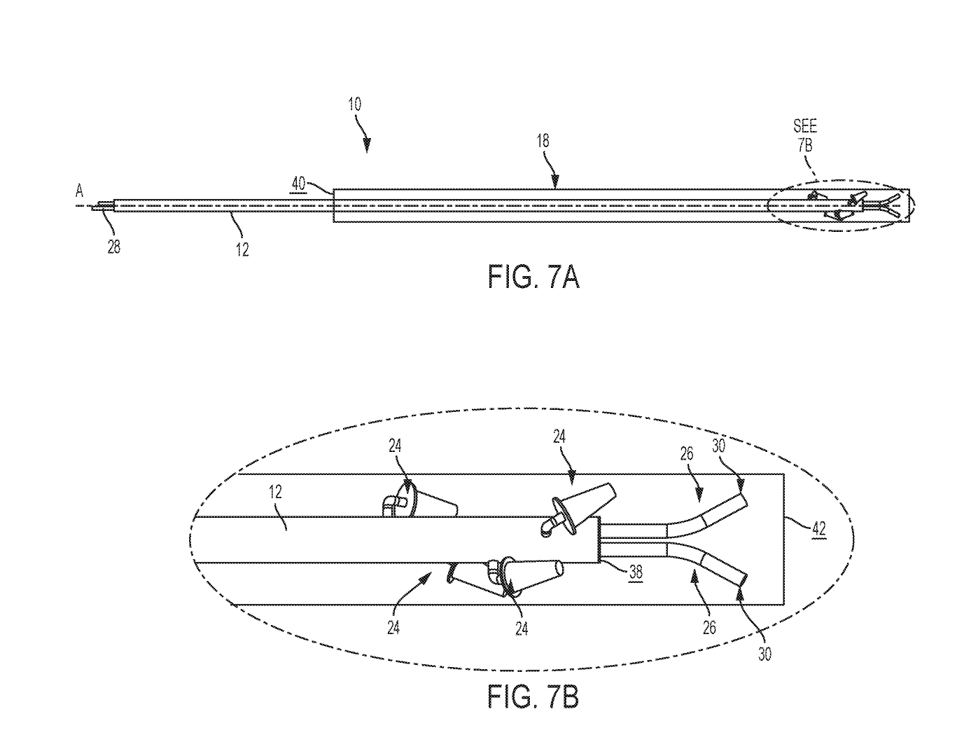

Lower portion 16 of core 12 includes gas outlet 22, upper gas outlets 24, and reagent outlets 30. Reagent outlets 30 and gas outlet 22 extend from the bottom surface 38 of core 12. Bottom surface 38 and top surface 36 of core 12 are welded closed to create a pressurized chamber as discussed further below. By welding bottom surface 38 closed, gas outlet 22 and reagent outlets 30 are welded to bottom surface 38 with reagent tubes 26 spanning the length of core 12. As shown in FIGS. 6A-6B, 7A-7E, and 10, reagent tube 26 extends downwardly away from bottom surface 38 and bends away from axis A (FIG. 6B) of core 12 defining an angle with axis A of core 12. Reagent tubes 26 bend away from axis A of core 12 such that reagent outlets 30 engage with the periphery of refractory element 18 as described further below. In an exemplary embodiment, the angle defined between reagent tubes 26 and axis A of core 12 may be as little as 0°, 15°, 20°, 25°, 30°, as great as 45°, 50°, 55°, 60°, 90°, or within any range defined between any two of the foregoing values, such as 0° to 90°.

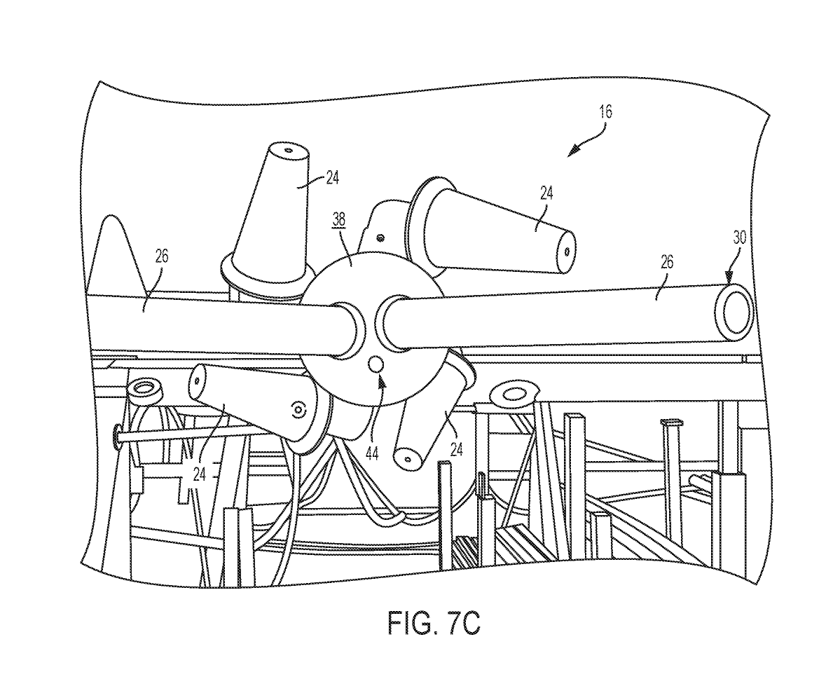

Gas outlet 22 (FIG. 2) is welded to bottom surface 38 of core 12 and extends a distance away from bottom surface 38 such that gas outlet 22 engages with bottom surface 42 of refractory element 18. In FIG. 7, an opening 44 is present along bottom surface 38 and may be configured to receive gas outlet 22; however, opening 44 may be welded closed as well. In an alternate embodiment, gas outlet 22 bends away from axis A of core 12 at an angle such that gas outlet 22 engages with the periphery of refractory element 18 where the angle defined between gas outlet 22 and axis A of core 12 may be as little as 0°, 15°, 20°, 25°, 30°, as great as 45°, 50°, 55°, 60°, 90°, or within any range defined between any two of the foregoing values, such as 0° to 90°.

Lower portion 16 of lance assembly 10 also includes upper gas outlets 24 positioned along the periphery of core 12 within refractory element 18. Both gas outlet 22 and upper gas outlets 24 are shown as frustoconical plugs. In an alternate embodiment, gas outlet 22 and upper gas outlets 24 may take the shape of a cylindrical plug, rectangular plug, or other suitable shape.

Upper gas outlets 24 are positioned at a distance above bottom surface 38 of core 12. In an exemplary embodiment, upper gas outlets 24 may be positioned at a distance above bottom surface 38 that is as little as 2 inches, 6 inches, 10 inches, 14 inches, as great as up to 4 inches below a top potion of lower portion 16, 6 inches below a top portion of lower portion 16, 8 inches below a top portion of lower portion 16, or within any range defined between any two of the foregoing values.

Upper gas outlets 24 extend from core 12 forming an angle between axis A of core 12 and upper gas outlet 24. In an exemplary embodiment, the angle defined between the reagent tubes 26 and axis A of core 12 may be as little as 0°, 15°, 30°, 45°, as great as , 55°, 60°, 75°, 90°, or within any range defined between any two of the foregoing values, such as 0° to 90°. In a further exemplary embodiment, upper gas outlets 24 may include as few as 1 outlet, 2 outlets, 3 outlets, 4 outlets, as great as 5 outlets, 6 outlets, 7 outlets, 8 outlets, or within any range defined between any two of the foregoing values.

As shown in FIGS. 7A-7D and FIGS. 8-10, upper gas outlets 24 are positioned along the periphery of core 12 such that the upper gas outlets are wrapped helically around core 12. In this way, carrier gas can be injected into the molten mixture through upper gas outlets 24 in a greater number of directions and at different depths. The mechanism in which lance assembly 10 operates with respect to the gas outlets 22, 24 provides benefits to the overall desulfurization process as discussed further below.

Similar to reagent tubes 26, gas outlet 22, regent inlets 28, and gas inlet 20, upper gas outlets 24 are welded to core 12 so that core 12 remains sealed and provides a pressurized chamber when lance assembly 10 is in operation. Upper gas outlets 24 also extend from core 12 such that upper gas outlets 24 engage with the periphery of refractory element 18 as described further below.

As shown in FIGS. 2-4, core 12 is welded closed at top surface 36, bottom surface 38, and at the junctions where gas inlet 20, and gas outlets 22, 24 couple to core 12. By welding core 12 closed, a pressurized chamber is created when carrier gas is injected into core 12. In an exemplary embodiment, the pressure within core 12 may be as little as 15 psi, 30 psi, 45 psi, 60 psi, 75 psi as great as 230 psi, 245 psi, 260 psi, 275 psi, or within any range defined between any two of the foregoing values, such as 30 psi to 260 psi. However, it is contemplated that in alternate embodiments, core 12 may operate at other suitable pressures. Pressurizing core 12 with carrier gas inhibits the molten mixture, within which lance assembly 10 is placed, from entering and potentially damaging refractory element 18 and reagent tubes 26 within core 12.

Lower portion 16 also includes refractory element 18. Refractory element 18 is coaxial with core 12 and includes a top surface 40 and a bottom surface 42. In the illustrated embodiment, refractory element 18 is shown to be a large cylinder made of steel that encompasses a portion of core 12 and support housing 32. In an alternate embodiment, refractory element 18 is of a spherical, rectangular prism, triangular prism, or any other suitable shape. In an alternate embodiment, refractory element is made of stainless steel or any other suitable metal.

Refractory element 18 also includes a plurality of openings around its periphery and bottom surface 42 that correspond with gas outlets 22, 24 and reagent outlets 30. When lance assembly 10 is fully assembled, the openings along bottom surface 42 and the periphery of refractory element 18 substantially align with gas outlets 22, 24 and reagent outlets 30. The openings are substantially the same size as reagent outlets 20 and gas outlets 22, 24, which provides for effective delivery of desulfurization reagents and carrier gas while also inhibiting molten metal solution from entering refractory element 18 and damaging parts of lance assembly 10.

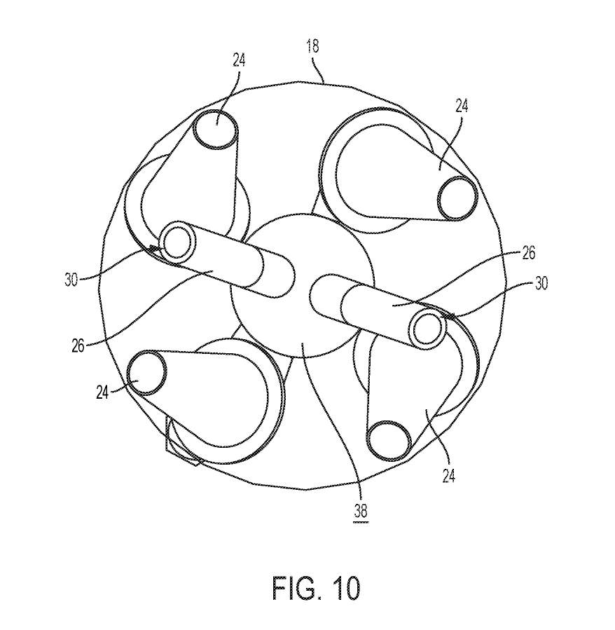

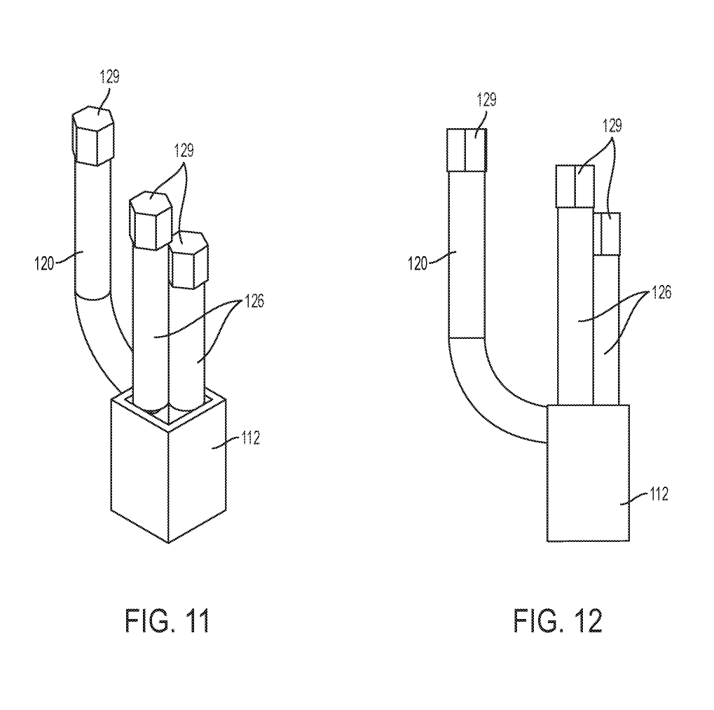

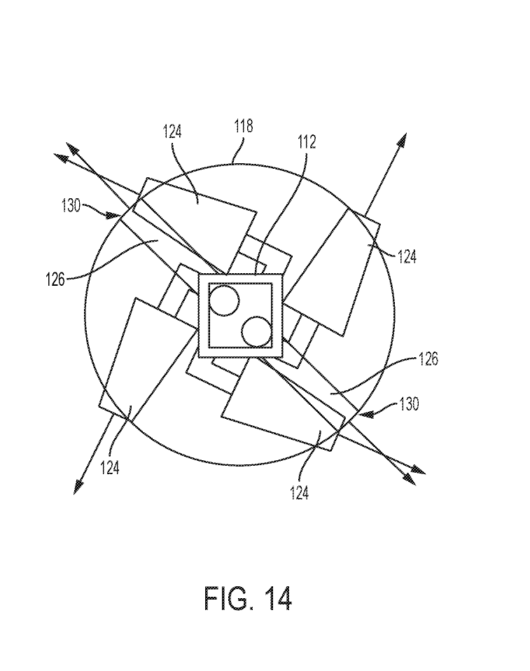

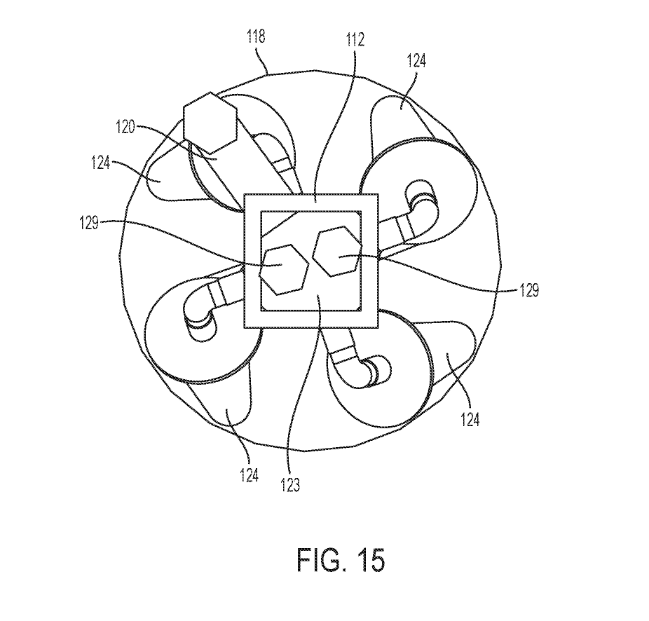

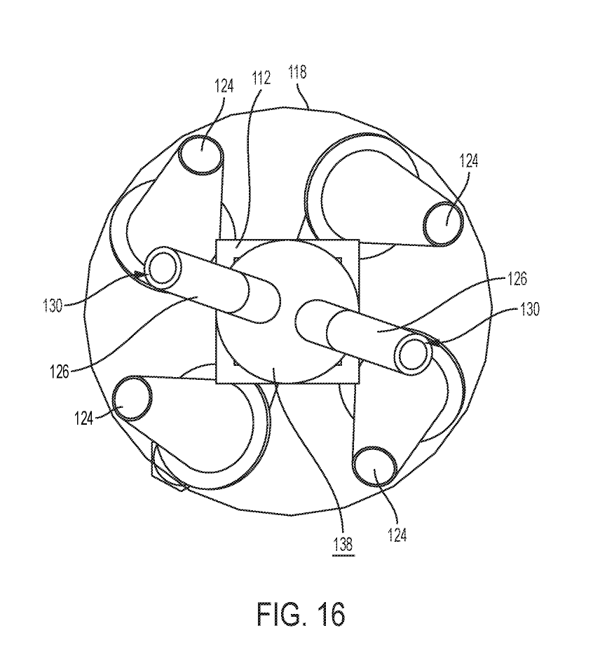

FIGS. 11-16 show an alternate embodiment of lance assembly 10 in lance assembly 110 (not on figures). Lance assembly 110 utilizes similar design features and operational principles as lance assembly 10 described above, and corresponding structures and features of lance assembly 110 have corresponding reference numerals to lance assembly 10, except with 100 added thereto. However, lance assembly 110 includes a core 112 and a support housing 132 that are different shapes than core 12 of lance assembly 10. In the illustrated embodiment, core 112 and support housing 132 are coaxial rectangular prisms. However, it is contemplated that in alternate embodiments, core 112 and support housing 132 may include other suitable shapes, such as cylinders.

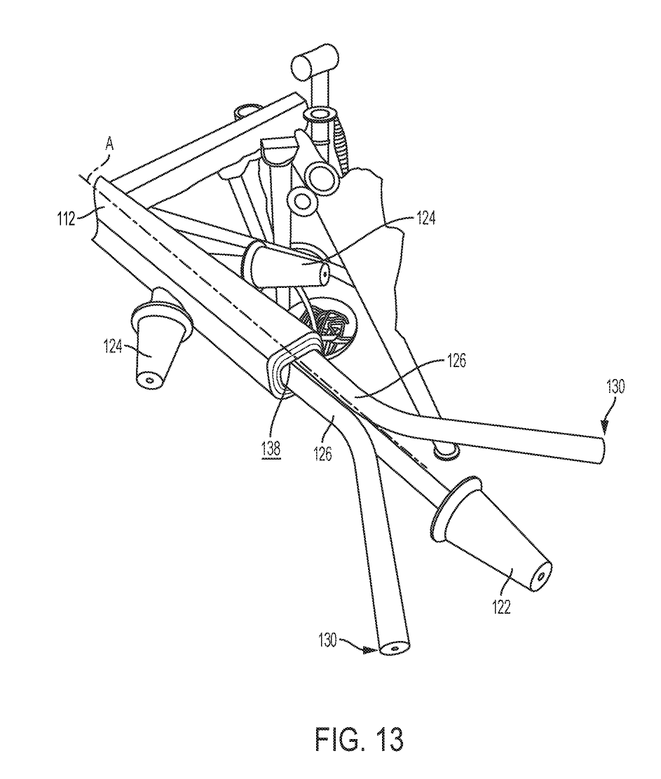

Lance assembly 110 may also include upper gas outlets 124 that are positioned differently along the periphery of core 112 than upper gas outlets 24 of lance assembly 10. As shown in FIG. 13, upper gas outlets 124 are positioned on opposite surfaces of the periphery of core 112 while the remaining surfaces of core 112 may not have an upper gas outlet 124 positioned along the surfaces. In an alternate embodiment, upper gas outlets 124 may be disposed on the same surface or adjacent surfaces of core 112. In the illustrated embodiment, similar to the gas outlet configurations of the embodiments shown in FIGS. 7A-7E, 8-10, and 14-16, carrier gas can be injected into the molten mixture through upper gas outlets 124 and corresponding openings on refractory element 118 in a greater number of directions and at different depths within the mixture, which provides benefits to the overall desulfurization as discussed further below.

In operation, lance assembly 10, 110 is inserted into a ladle (not shown) containing a hot molten metal mixture (not shown). A carrier gas and desulfurization reagents are provided to lance assembly 10, 110 via gas inlet 20, 120 and reagent tube 26, 126, respectively. In an exemplary embodiment, the carrier gas comprises nitrogen gas or argon, and the desulfurization reagents are lime and/or magnesium. In alternate embodiments, other suitable carrier gases (e.g., helium, hydrogen, or any other inert gas) and desulfurization reagents (e.g., calcium carbide, calcium oxide, calcium fluoride, magnesium oxide, and crystalline silica, or a blend thereof such as lime/spar) may be used. The desulfurization reagents flow through reagent tubes 26, 126 into the molten solution via reagent outlets 30, 130 and their corresponding lance openings. The carrier gas that is fed through gas inlet 20, 120 remains within core 12, 112 as pressure within core begins to accumulate. When core 12, 112 becomes over pressurized with carrier gas, upper gas outlets 24, 124 and gas outlet 22, 122 serve as pressure releases by injecting carrier gas from core 12, 112 into the mixture. By this process, carrier gas is continually injected into the molten solution at different locations within the solution based on the location of the gas outlets 22, 24, 122, 124.

Advantageously, the continual injection of the carrier gas keeps the previously injected desulfurization reagents within the molten mixture for a greater period of time. This allows the desulfurization reagents to react with the molten mixture for a longer period of time, resulting in a greater reaction yield. Further, less desulfurization reagents are needed for the desulfurization process, resulting in significant savings in raw material costs. In an exemplary embodiment, there is a 10-20% reduction in the amount of desulfurization reagents needed for the desulfurization process with lance assembly 10, 110.

Additionally, there is no need to rotate lance assembly 10, 110 as the reagent and carrier gas are injected in multiple directions and at different depths within the molten mixture. By not rotating lance assembly 10, further savings on maintenance and operational costs are realized by the user as fewer moving parts and processing units are involved.

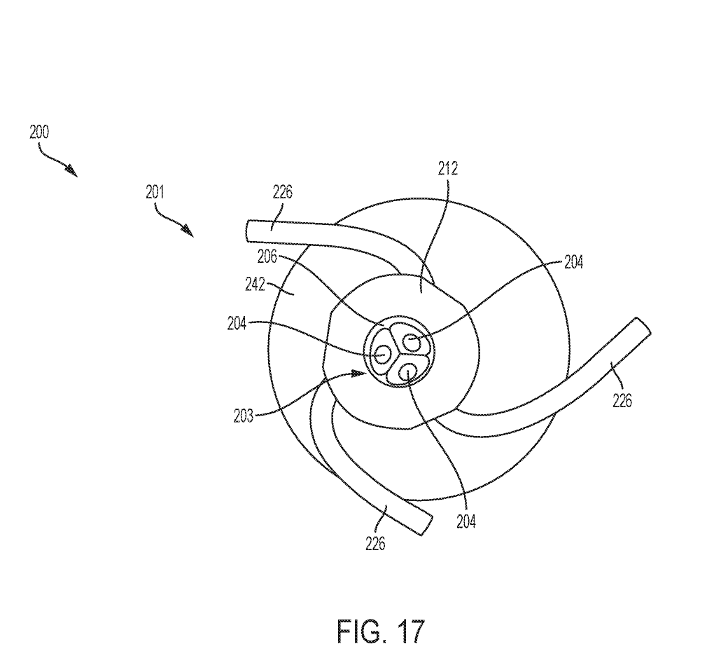

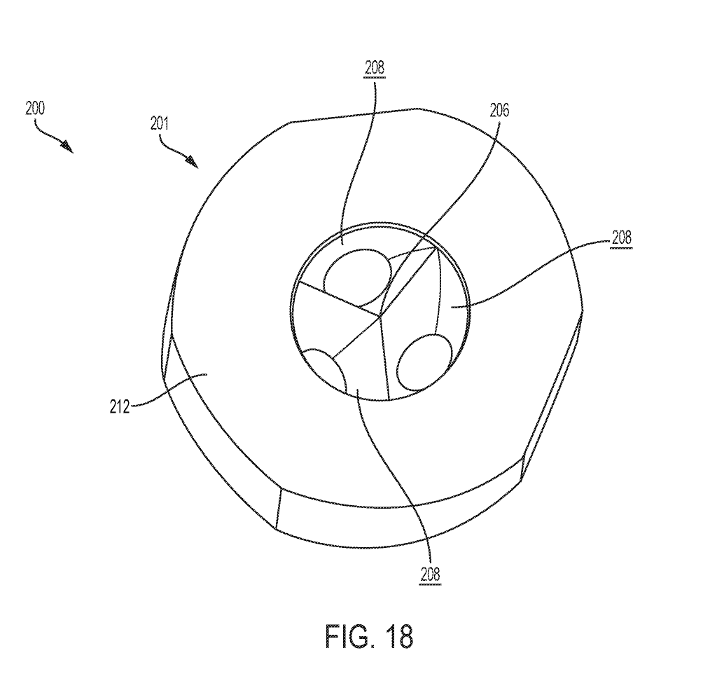

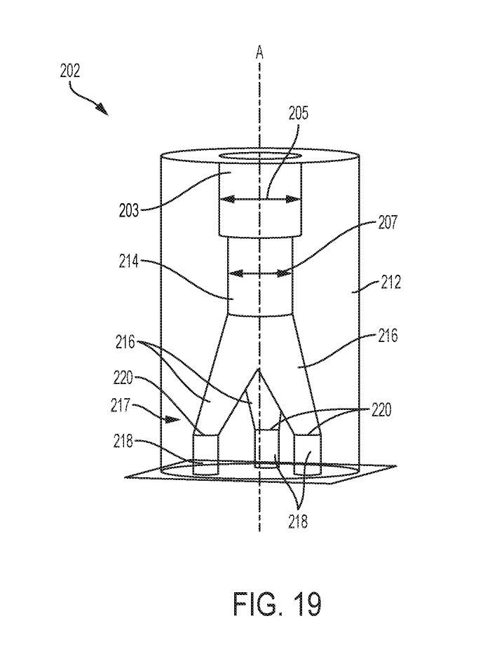

FIGS. 17-22 show an alternate lance assembly 200. Lance assembly 200 includes an upper portion 201 (FIGS. 17 and 18) and a lower portion 202 (FIGS. 19-21). Upper portion 201 includes manifold 212 and reagent tube 203. In one embodiment, reagent tube 203 is coaxial with manifold 212. However, it is contemplated that in alternate embodiments, reagent 203 and manifold 212 are not coaxial with each other. Reagent tube 203 includes apertures 204 and edges 206 that are positioned at one end of reagent tube 203. In the illustrated embodiment, three apertures 204 exist; each aperture making up one third of the area of reagent tube 203. However, it is contemplated that in alternate embodiments, alternate configurations of apertures 204 may be used (e.g., a single aperture, dual apertures 204 each counting for half the area of reagent tube 203, etc.). In one embodiment, each aperture 204 maybe an end of a cylindrical tube that runs the length of manifold 212, where each cylindrical tube occupies the same volume within reagent tube 203. In an alternate embodiment, apertures 204 provide openings for desulfurization reagents to enter manifold 212 where desulfurization reagents are mixed together after passing through one of apertures 204.

Edges 206 are welded to reagent tube 203 and separate apertures 204 from each other. In an alternate embodiment, edges 206 are coupled to reagent tube 203 by other suitable means such as couplers, fasteners, etc. In the illustrated embodiment, edges 206 form a Y-shaped pattern at one end of the reagent tube 203. Edges 206 are pointed and sharp to inhibit desulfurization reagents from coagulating and clogging manifold 212 while lance assembly 200 operates and desulfurization reagents pass through manifold 212. In other words, edges 206 serve to break up clotting of desulfurization reagents. Edges 206 are also inclined such that the intersection of the edges within reagent tube 203 is the highest point of edges 206, and each of edges 206 decrease in height with distance toward the edge of reagent tube 203. The inclined configuration of edges 206 serves to further inhibit coagulation of the desulfurization reagents that could clot manifold 212 while in operation.

While an inclined Y-shaped configuration is shown for edges 206, it is contemplated that alternate configurations for edges 206 may be used (e.g., a level T-shaped configuration, an inclined T-shaped configuration, a level Y-shaped configuration, etc.).

Reagent tube 203 also includes surfaces 208 surrounding apertures 204 that are positioned between apertures 204 and edges 206 of reagent tube 203. In the illustrated embodiment, the highest portion of surfaces 208 are near edges 206 and surfaces 208 slope downwardly with distance toward apertures 204 to form a downward sloping configuration. The downward sloping configuration of surfaces 208 serves to inhibit coagulation and clotting of desulfurization reagents within manifold 212 and reagent tube 203 by using transport gas pressure and gravity to help move desulfurization reagents into apertures 204. However, it is contemplated that in alternate embodiments, surfaces 208 are flat.

In one exemplary embodiment, desulfurization reagents entering reagent tube 203 include lime and magnesium with a carrier gas. In an exemplary embodiment, the carrier gas includes nitrogen gas or argon gas. However, it is contemplated that in alternate embodiments, other desulfurization reagents may be used, such as calcium carbide, calcium oxide, calcium fluoride, magnesium oxide, crystalline silica, or a blend thereof such as lime/spar, and other suitable carrier gases, such as helium, hydrogen, or any other inert gas.

FIGS. 19-21 show a lower portion 202 of lance assembly 200. Lower portion 202 includes a continuation of manifold 212 and reagent tube 203 from upper portion 201, a second cylinder 214, and outlets 217 that each include an upper portion 216 and a lower portion 218.

Reagent tube 203 and second cylinder 214 are coupled to each other. In the illustrated embodiment, second cylinder 214 frictionally engages with reagent tube 203. However, it is contemplated that in an alternate embodiment, reagent tube 203 and second cylinder 203 are coupled to each other by other suitable means such as couplers, fasteners, etc. Second cylinder 214 is coupled to reagent tube 203 such that desulfurization reagents flowing through reagent tube 203 and into second cylinder 214 does not accumulate along the side walls of either cylinder 203, 214. Second cylinder 214 has an outer diameter 207 that is greater than the inner diameter of reagent tube 203 but less than the outer diameter 205 of reagent tube 203. When coupled together, the difference in diameters between reagent tube 203 and second cylinder 214 assist to inhibit coagulation and accumulation of desulfurization reagents along the side walls of either reagent tube 203 or second cylinder 214 as the transition between reagent tube 203 and second cylinder 214 is smooth. The smooth transition enables desulfurization reagents to flow through without adhering to the walls or the interface of second cylinder 214 and reagent tube 203.

As desulfurization reagents move downward through second cylinder 214, desulfurization reagents will split off into multiple outlets 217 which are coupled to the bottom surface of manifold 212. Outlets 217 include an upper portion 216 and a lower portion 218. In the illustrated embodiment, upper portion 216 is angled with respect to the central axis of second cylinder 214. However, it is contemplated that in alternative embodiments upper portion 216 is parallel with the central axis of cylinder 214.

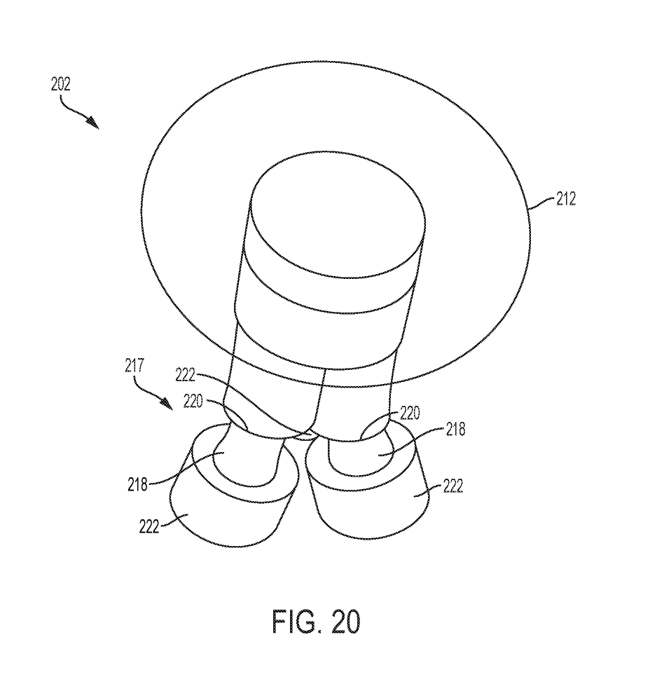

Upper portion 216 funnels desulfurization reagents downward to lower portion 218, which is coupled to upper portion 216 at junction 220. As shown in FIG. 19, lower portion 218 is substantially parallel with the central axis of cylinder 214. However, it is contemplated that in alternate embodiments (FIG. 20) lower portion 218 is angled with respect to the central axis of cylinder 214.

As mentioned earlier, upper portion 216 and lower portion 218 are coupled at junction 220. In an exemplary embodiment, upper portion 216 is rounded so that a pointed edge is not formed at junction 220. Enhancing the curvature of upper portion 216 at junction 220 eases the transition between upper portion 216 and lower portion 218 and enables desulfurization reagents to move from upper portion 216 to lower portion 218 without coagulating or attaching to the inner walls of either upper portion 216 or lower portion 218.

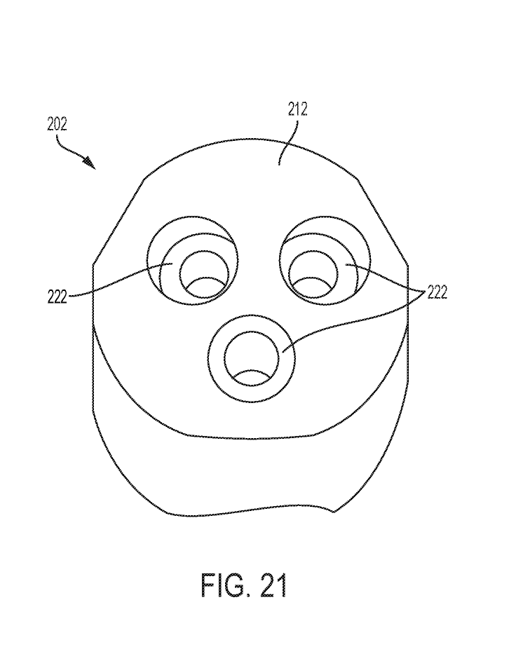

Lower portion 218 includes an outlet cylinder 222 coupled to lower portion 218 as shown in FIGS. 20 and 21. In an alternate embodiment, outlet cylinders 222 may be integrally formed with lower portions 218. As shown in FIG. 21, outlet cylinders 222 are positioned at different heights with respect to the bottom surface of manifold 212. By varying the location of outlet cylinders 222 within manifold 212, desulfurization reagents can be injected at various levels within the molten material for desulfurization as further described below.

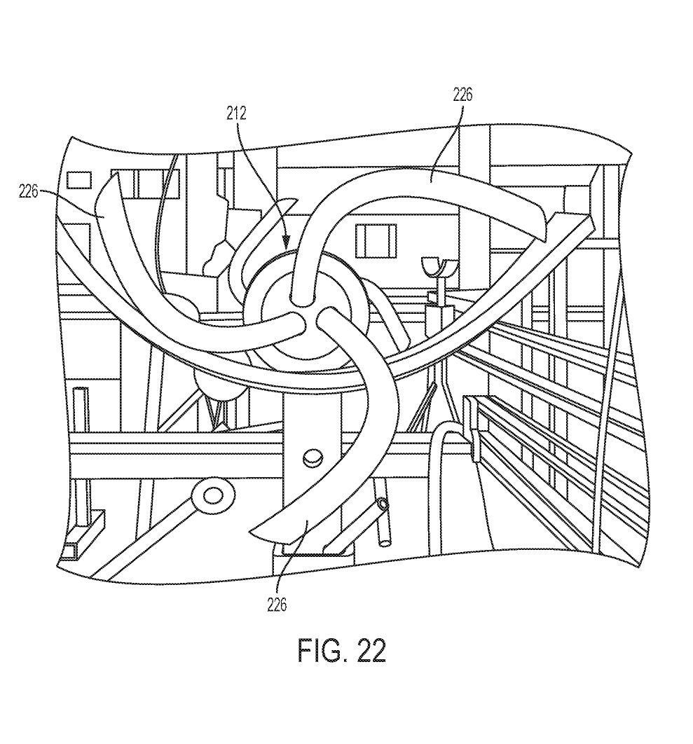

The bottom surface of outlet cylinders 222 are coupled with reagent tubes 226 (FIG. 22), which extend from the bottom surface of manifold 212. Reagent tubes 226 serve to inject desulfurization reagents into the molten material for the purposes of desulfurization. In one embodiment, reagent tubes 226 are frictionally engaged with outlet tubes 222. In an alternate embodiment, reagent tubes 226 may be coupled to outlet tube 222 by other suitable means such as fasteners, couplers, etc.

As shown in FIG. 22, each reagent tube 226 has its own curvature with respect to the central axis A (FIG. 19) of manifold 212. In one embodiment, reagent tube 226 extends a distance from manifold 212 and bends away from axis A of manifold 212 at an angle relative to axis A of manifold 212. The angle may be as little as 0°, 15°, 20°, 25°, 30°, as great as 45°, 50°, 55°, 60°, 90°, or within any range defined between any two of the foregoing values, such as 0° to 90.

Each reagent tube 226 also varies in distance from the bottom surface of manifold 212, which promotes improved application of the desulfurization reagents into the molten material during operation. Having different orientations of reagent tubes 226 at various heights within the molten mixture allow desulfurization reagents and carrier gas to be injected in multiple directions and at different depths within the molten mixture. As a result, there is no need to rotate lance assembly 200 as effective application of desulfurization reagents within the solution is achieved. By not rotating lance assembly 200, further savings on maintenance and operational costs are realized by the user since fewer moving parts and processing units are involved.

The configuration of lance assembly 200 does not require a separate gas line. Desulfurization reagents, as described above, and can enter lance assembly 200 and be injected into the molten mixture for effective desulfurization. By having an assembly that does not require a separate gas line, savings in maintenance and equipment costs are realized. Furthermore, the configuration of reagent tubes 226 also permits continuous injection of desulfurization reagents into the molten mixture. This keeps the desulfurization reagents within the molten mixture for a greater period of time, which allows the desulfurization reagents to react with the molten mixture for a greater period of time, and improves the reaction yield. Also, less desulfurization reagents are needed for the desulfurization process, resulting in significant savings in raw material costs. In one exemplary embodiment, 15-20% less desulfurization reagents are needed for desulfurization.

In one embodiment, reagent tubes 226, outlet tubes 222, outlets 217, second cylinder 214, reagent tube 203, and manifold 212 are made from stainless steel. However, it is contemplated that in alternate embodiments other suitable materials (e.g., iron) may be used.

Lance assembly 200 is encased by a refractory element (not shown). As shown in FIG. 17, bottom plate 242 is positioned below reagent outlet tubes 226. In one embodiment, bottom plate 242 of refractory element is positioned as little as 2 inches, 4 inches, 6 inches, or as great as 8 inches, 10 inches, 12 inches below reagent tubes 226, or within any range defined therebetween. Bottom plate 242 forms a bottom surface of the refractory element. In one embodiment, the refractory element is a cylinder. In an alternate embodiment, the refractory element is a rectangular prism.

The edges of the refractory element that extend vertically from bottom plate 242 engage with reagent tube 226 such that reagent tubes 226 are not exposed to the molten mixture by extending outside the vertical edges. In one embodiment, the vertical edges of refractory element and the outlets of regent tubes 226 are frictionally engaged. In an alternate embodiment, the vertical edges of the refractory element and the outlets of reagent tubes 226 may be coupled to each other by other suitable means such as fasteners, couplers, etc. The vertical surfaces and the outlets of reagent tubes 226 form a tight fit such that the refractory element cannot slideably move along lance assembly 200. In one embodiment, the refractory element has a top surface that engages at a point along manifold 212 of lance assembly 200 leaving a portion of manifold 212 exposed. In an alternate embodiment, the refractory element envelopes manifold 212 such that manifold 212 is not exposed.

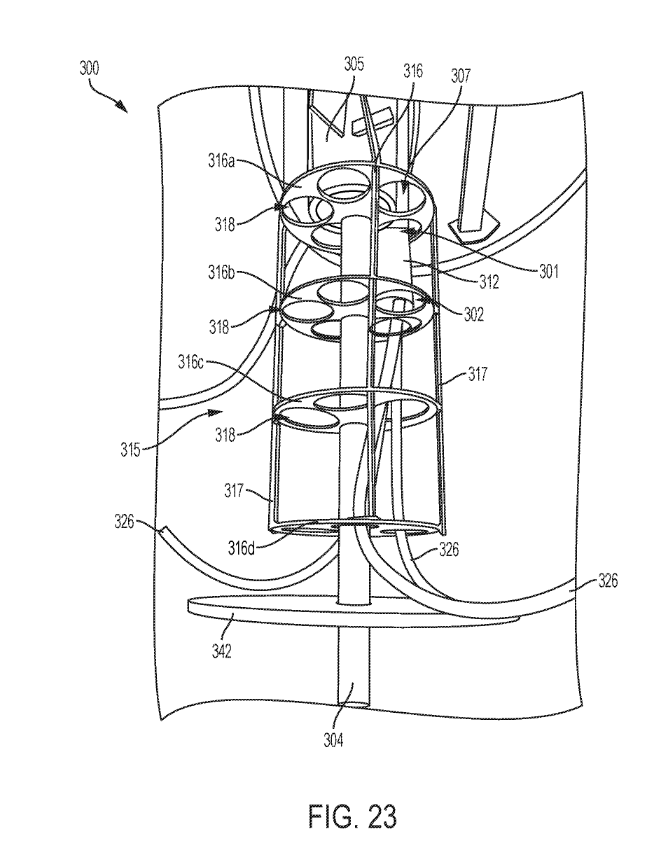

Referring to FIG. 23, a third embodiment of lance assembly 300 is shown. Lance assembly 300 includes a core 305, having a reagent tube 304 passing therethrough. Reagent tube 304 extends from the bottom of core 305 and beyond bottom plate 342 of refractory element (not shown). Reagent tube 304 is configured to receive and pass desulfurization reagents and carrier gases through core 305. In one embodiment, desulfurization reagents include lime and/or magnesium, and carrier gases include nitrogen gas or argon. In alternate embodiments, other suitable carrier gases (e.g., helium, hydrogen, or any other inert gas) and desulfurization reagents (e.g., calcium carbide, calcium oxide, calcium fluoride, magnesium oxide, and crystalline silica, or a blend thereof such as lime/spar) may be used.

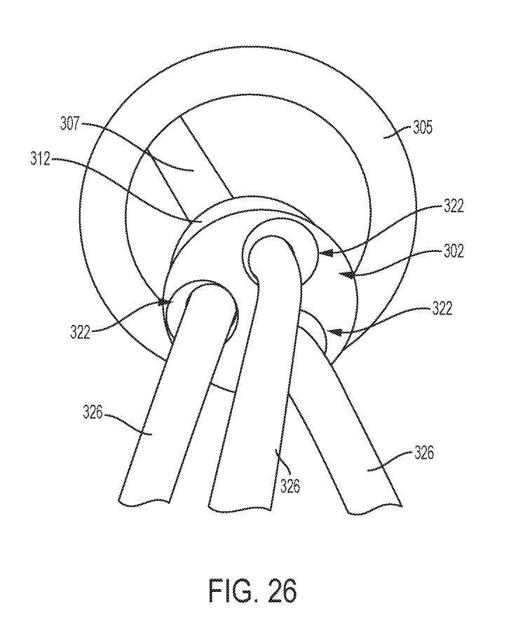

Lance assembly 300 also includes manifold 312 coupled to core 305. As shown in FIG. 23. manifold 312 is coupled to the side of core 305. However, it is contemplated that in alternate embodiments, manifold 312 may be positioned within core 305 and coaxial with reagent tube 304 or within core 305 as shown in FIG. 26. As shown in FIG. 26, reagent tube 307 is provided within core 305, and manifold 312 is coupled to reagent tube 307. At lower portion 302 of core 305, reagent outlet tubes 326 extend from outlets 322 of manifold 312 as discussed herein.

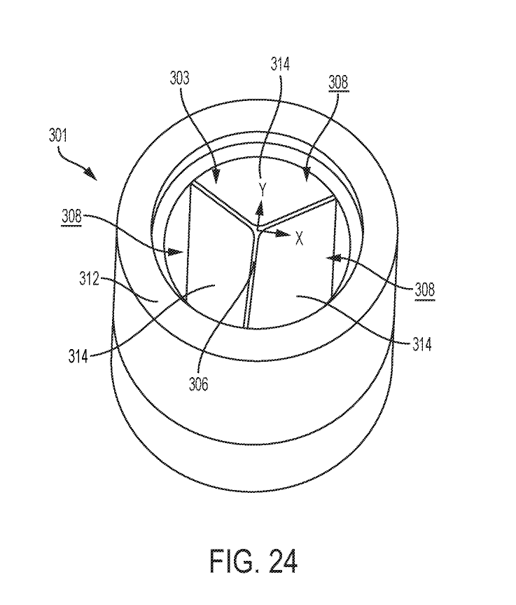

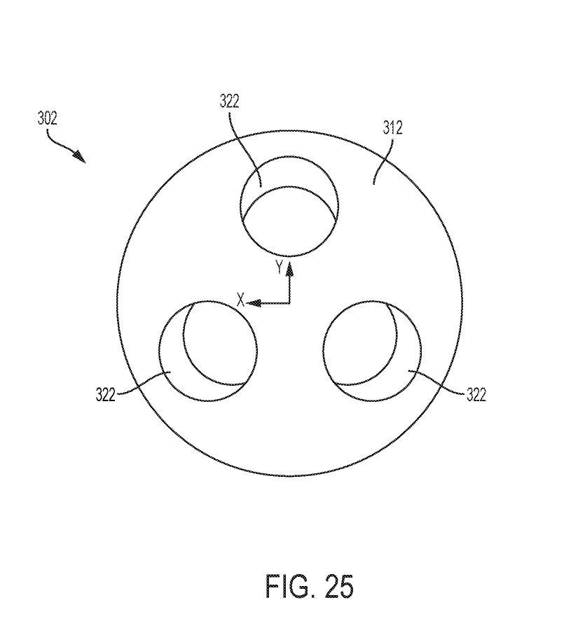

As shown in FIGS. 24 and 25, manifold 312 is similar in structure as manifold 212. Manifold 312 includes an upper portion 301 (FIG. 24) and a lower portion 302 (FIG. 25). Upper portion 301 includes an interior reagent tube 303 within manifold 312, which includes openings 314 that are configured to receive desulfurization reagents (e.g., magnesium, lime, or a mixture thereof, etc.) from a reagent tube 307 that is coupled to interior reagent tube 303.

Openings 314 are separated from each other by edges 306 shown in FIG. 24. Similar to edges 206 (FIG. 17), edges 306 separate apertures 314 from each other. In an alternate embodiment, edges 306 are coupled to reagent tube 307 by other suitable means such as couplers, fasteners, etc. In the illustrated embodiment, edges 306 form a Y-shaped pattern at one end of the interior reagent tube 303. Edges 306 are pointed and have a sharp edge to inhibit desulfurization reagents from coagulating and clogging manifold 312 while desulfurization reagents pass through manifold 312 during operation of lance assembly 300. In other words, edges 306 function to break up clotting of desulfurization reagents. Edges 306 are also inclined such that the intersection of the edges within reagent tube 307 is the highest point of the intersection of edges 306, and each of edges 306 decrease in height with distance toward the edge of reagent tube 307. The inclined configuration of edges 306 serves to further inhibit coagulation of the desulfurization reagents that could clot manifold 312 while in operation.

Lower portion 302 of manifold 312 includes a plurality of outlets 322 each of which correspond to at least one of apertures 314. Outlets 322 are coupled to reagent outlet tubes 326 (FIG. 23). Reagent outlet tubes 326 operate as conduits for injecting desulfurization reagents and/or carrier gas into the molten solution within which lance assembly 300 is inserted. Reagent outlet tubes 326 are made from plastic tubing, which can include compounds such as polyvinyl chloride (PVC) tubing, high density polyethylene (HDPE) plastic tubing, perfluoroalkoxy alkane (PFA) plastic tubing, and fluorinated ethylene propylene (FEP) plastic tubing. However, it is contemplated that other compositions may be used such as other ferrous materials or non-ferrous materials, which includes different grades of stainless steel, different grades of steel, aluminum, and iconel.

As shown in FIG. 23, reagent outlet tubes 326 curve outwards from lower portion 302 and extend such that the outlet of reagent outlet tubes 326 are flush with the refractory element (not shown). When initially assembled within the refractory element, portions of reagent outlet tubes 326 extend beyond the outer surface of the refractory element. Reagent outlet tubes 326 burn out during the firing process leaving a refractory outlet port.

Further, reagent outlet tubes 326 curve outwardly in different directions in order to improve distribution of desulfurization reagents within the molten solution within which lance assembly 300 is placed. Additionally, by varying the location of reagent outlet tubes 326, rotation of the molten solution may result from the varied injection points of the desulfurization reagents, which yields improved desulfurization properties as discussed below.

Due to the materials used in reagent outlet tubes 326 (e.g., plastic tubing), reagent outlet tubes 326 experience substantially less plugging when desulfurization reagents pass through. This reduction in plugging yields improved desulfurization capabilities of lance assembly 300 as a reduced amount of desulfurization agents are needed to achieve sufficient desulfurization of the molten solution. In other words, in an exemplary embodiment, less lime and/or magnesium is needed. In one exemplary embodiment, 10-25% less reagent is needed. Furthermore, the resulting rotational motion of the molten solution from injection of desulfurization reagents also reduces the amount of desulfurization reagents used due to the improved distribution of desulfurization reagents within the molten solution. By requiring a reduced amount of reagents for the desulfurization process, a significant amount of savings in material costs is achieved. There also is a reduction in processing time.

Referring back to FIG. 23, a cage 315 is shown; cage 315 is adjacent to an end of core 305. Cage 315 is co-axial with and coupled to reagent tube 304 and includes a plurality of discs 316a-d that are held in alignment with one another by a plurality of rods 317 that are coupled to discs 316a-d. Each disc 316a-d includes apertures 318 that are positioned radially around the center of discs 316a-d and are in alignment with apertures 318 of other discs 316a-d. As shown in FIG. 23, reagent outlet tubes 326 are fed through aligned apertures 318 to inhibit substantial movement of tubes 326 after assembly. However, it is contemplated that in alternate embodiments, reagent outlet tubes are fed through apertures 318 that are not in substantial alignment with one another.

Due to the configuration of cage 315, additional manifolds 312 (with additional reagent outlet tubes 326) may be coupled externally to core 305 where the additional reagent outlet tubes 326 of the additional manifolds are fed through different or unoccupied aligned apertures 318 of cage 315 to inhibit entanglement. By having numerous manifolds 312 and reagent outlet tubes 326 positioned around core 305 of lance assembly 300, there are additional outlet ports of lance assembly 300 such that a greater amount of desulfurization reagents and carrier gas can be injected into the molten solution, as needed, yielding the aforementioned advantages.

### EXAMPLES

### Example 1

TABLE 1
Average Amount of Reagent Used in Desulfurization

| | Maximum Average | Average Magnesium | Average Sulfur |
|---|---|---|---|
| | Sulfur | Used (pounds of | Concentration |
| | Concentration | Magnesium per part | After |
| Lance | Before Treatment | of sulfur per ton | Treatment |
| Assembly | (ppm) | of hot metal) | (ppm) |
| Assembly 1 | 0.0051 | 87 | 0.0010 |
| Assembly 2 | 0.0062 | 96 | 0.0014 |

Example 1 tested two lance assemblies under the same conditions to measure their respective effectiveness in desulfurization applications. During operation, a carrier gas of nitrogen was injected into the core of the lance assembly to create a pressurized chamber of 80-85 psi within the core, and magnesium and lime were added to the lance assembly via the reagent tubes. Assembly 1 was the lance of the present disclosure, while Assembly 2 was a standard lance previously used. As shown in Table 1, Assembly 1 required an average amount of 87 pounds of magnesium per part of sulfur per ton of hot metal used, to achieve an approximate 80% reduction in sulfur content. Assembly 2 required 96 pounds of magnesium per part of sulfur per ton of hot metal used to achieve an approximate 77% reduction in sulfur content. The data showed that with Assembly 1, a greater amount of sulfur was removed while using approximately 10% less reagent (lime and magnesium) as compared to Assembly 2.

While this invention has been described as having exemplary designs, the present disclosure can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A lance assembly comprising:
a refractory element having a length;
a core coaxial with the refractory element and extending substantially through the length of the refractory element, the core including:
a reagent pipe extending substantially through the core;
a manifold coupled to the reagent pipe, the manifold coupled to a plurality of reagent outlet tubes that extend from the manifold, wherein each reagent outlet tube has a curvature different from other reagent outlet tubes.

2. The lance assembly of claim 1, wherein the manifold includes an inlet and an outlet, the inlet includes a plurality of openings and a plurality of edges positioned around the plurality of openings such that each of the plurality of openings is separated from the other openings; the outlet including a plurality of outlets coupled to the plurality of reagent outlet tubes.

3. The lance assembly of claim 2, wherein the plurality of edges are positioned in a Y-shaped configuration.

4. The lance assembly of claim 2, wherein the plurality of edges are inclined.

5. The lance assembly of claim 1, wherein the reagent pipe is configured to receive a reagent and a carrier gas at the inlet; the reagent including lime or magnesium; and the carrier gas including argon, nitrogen, or any other inert gas.

6. The lance assembly of claim 1, wherein the plurality of reagent outlet tubes are made from plastic, stainless steel, or other ferrous or non-ferrous materials and are configured to substantially inhibit plugging of the lance assembly.

7. The lance assembly of claim 6, wherein the plurality of reagent outlet tubes are made from a plastic selected from the group consisting of: polyvinyl chloride (PVC), high density polyethylene (HDPE), perfluoroalkoxy alkane (PFA), and fluorinated ethylene propylene (FEP).

8. The lance assembly of claim 6, wherein the angle at which at least one of the reagent outlet tubes extending from the manifold is between 0 and 90 degrees relative to the axis of the core.

9. The lance assembly of claim 1, wherein the manifold includes a second cylinder coupled to a tube configured to receive reagents, the reagents including lime, magnesium, calcium carbide, calcium oxide, calcium fluoride, magnesium oxide, crystalline silica, or a blend thereof such as lime/spar; and the carrier gas including argon, nitrogen, or any other inert gas.

10. The lance assembly of claim 9, wherein the second cylinder includes a plurality of outlets, each of the plurality of outlets having an upper portion and a lower portion.

11. The lance assembly of claim 10, wherein the upper portion of each of the outlets is angled with respect to a central axis of the manifold.

12. The lance assembly of claim 1, further comprising a cage adjacent to the core, wherein the core is coaxial with the reagent tube and the reagent tube extends substantially through the cage, the cage including a plurality of apertures through which the reagent tube and the reagent outlet tubes each pass through one of the plurality of apertures.

13. A lance assembly comprising:
a refractory element having a length;
a core coaxial with the refractory element and extending substantially through the length of the refractory element, the core including:
a reagent pipe extending substantially through the core;
a manifold coupled to the reagent pipe, the manifold coupled to a plurality of reagent outlet tubes that extend from the manifold, the plurality of reagent outlet tubes configured to substantially inhibit plugging of the lance assembly;
a cage adjacent to the core, wherein the core is coaxial with the reagent tube and the reagent tube extends substantially through the cage, the cage including a plurality of apertures through which the reagent tube and the reagent outlet tubes each pass through one of the plurality of apertures.

14. The lance assembly of claim 13, wherein the manifold includes an inlet and an outlet, the inlet includes a plurality of openings and a plurality of edges positioned around the plurality of openings such that each of the plurality of openings is separated from the other openings; the outlet including a plurality of outlets coupled to the plurality of reagent outlet tubes.

15. The lance assembly of claim 14, wherein the plurality of edges are inclined and positioned in a Y-shaped configuration.

16. The lance assembly of claim 13, wherein the reagent pipe is configured to receive a reagent and a carrier gas at the inlet; the reagent including lime, magnesium calcium carbide, calcium oxide, calcium fluoride, magnesium oxide, crystalline silica, or a blend thereof such as lime/spar; and the carrier gas including argon, nitrogen, or any other inert gas.

17. The lance assembly of claim 13, wherein the plurality of reagent outlet tubes are made from a plastic selected from the group consisting of: polyvinyl chloride (PVC), high density polyethylene (HDPE), perfluoroalkoxy alkane (PFA), and fluorinated ethylene propylene (FEP).

18. The lance assembly of claim 1, wherein the manifold is flush with a bottom surface of the refractory element.

19. The lance assembly of claim 1, wherein the manifold is flush with a bottom surface of the refractory element.
